(19) United States
(12) Patent Application Publication
(10) Pub. No.: US 2005/0025850 A1
(43) Pub. Date: Feb. 3, 2005

(54) Pottery wheel with a guiding device for molding

(75) Inventor: Mathias D'Estais, Cairon (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: Heller, a corporation of France, Trun (FR)

(21) Appl. No.: 10/889,445

(22) Filed: Jul. 12, 2004

Related U.S. Application Data
(63) Continuation of application No. PCT/FR03/00174, filed on Jan. 20, 2003.

(30) Foreign Application Priority Data
Jan. 18, 2002 (FR) 02/00636

(51) Int. Cl. B28B 1/02

(52) U.S. Cl. 425/263

(57) ABSTRACT

A pottery wheel for shaping pottery of the type including a base supporting a disk that can be driven in rotation along an axis of rotation A, and a guiding device that enables operations on the pottery of diametrically opposed manual efforts in relation to the axis of rotation (A) of the disk by at least one tool.

### RELATED APPLICATION

This is a continuation of International Application No. PCT/FR03/00174, with an international filing date of Jan. 20, 2003, which is based on French Patent Application No. 02/00636, filed Jan. 18, 2002.

### FIELD OF THE INVENTION

This invention pertains to the field of creation of pottery using pottery wheels, especially for the creation of pottery by children. The invention pertains more particularly to a pottery wheel for shaping pottery with a base supporting a disk that can be driven in rotation according to an axis of rotation.

### BACKGROUND

Pottery wheels for shaping pottery are already known in the prior art.

There exists notably a device described in AU 1,503,477. This system enables centering of a lump of clay by the pressure of a unique tool. This tool is mobile along an arm. This arm can be oriented in all directions by a handle located in the extension of the arm. An advantage of this type of system is to facilitate the centering of the clay, an operation which is a source of serious difficulties for the novice.

That system enables centering the lump of clay, but does not enable the act itself of shaping the pottery during which act a shape is given to the pottery and during which process a relief decoration can be created on the external surface of the pottery. Moreover, that device only comprises a single centering arm. Therefore, it is poorly suited for modeling small objects. In this case, in fact, the lump of clay is of small size and can easily become separated from the disk.

Finally, it does not make it possible for the user to be suitably guided when the user imitates the motions of the potter normally performed with bare hands and, thus, does not enable an easy introduction to the techniques of the potter craftsman.

Also known in the prior art is DE 3418067, which pertains to a central piercing wheel comprising a tray that can be driven in rotation according to an axis of rotation. That device is equipped with a piercing ring mounted on an axis parallel with the axis of rotation of the tray enabling piercing of pottery in its center. Moreover, it comprises fixed centering sides that can be supported for the centering of the ball. It must be noted that the piercing ring does not enable assisting of the external shaping of the pottery because the piercing ring is vertically mobile along this axis of rotation.

Also known in the prior art is GB 1,603,708, which pertains to a wheel for the decoration of pottery. That wheel is equipped with a tray that can be driven in rotation along an axis of rotation. Moreover, it comprises a single arm having a point at its end and that can be driven in sweeping movement above the tray by rotation along an axis parallel to the axis of rotation of the tray. That wheel does not really enable performance of shaping in the manner of traditional shaping.

Finally, also known in the prior art is U.S. Pat. No. 5,047,194, which pertains to a pottery wheel for shaping pottery of the type comprising a base supporting a disk that can be driven in rotation along an axis of rotation. That wheel is equipped with a shaping tool mobile in different directions and having an ejection tube having at its distal end an ejection nozzle through which is ejected a flow of water. Thus, shaping is not performed in a traditional manner by manual efforts, but rather by blasting water.

### SUMMARY OF THE INVENTION

This invention relates to a pottery wheel for shaping pottery including a base supporting a disk that can be driven in rotation along an axis of rotation (A), a guide including means enabling operations on the pottery of diametrically opposed manual efforts in relation to the axis of rotation (A) of the disk by at least one tool.

This invention also relates to a pottery wheel for shaping pottery including a base supporting a disk that can be driven in rotation along an axis of rotation (A), a guide enabling manipulation of the pottery by opposed manual efforts in relation to the axis of rotation (A) of the disk with at least one tool.

### BRIEF DESCRIPTION OF THE DRAWINGS

Better comprehension of the invention will be obtained from the description presented below for purely explanatory purposes of a mode of implementation of the invention with reference to the attached figures:

FIG. 1 is a perspective view of a pottery wheel according to aspects of the invention;

FIG. 2 is a detail view of a preferred embodiment of the guiding device;

FIG. 3 is a detail view of a tool with interchangeable work surface; and

FIG. 4 is a detail view of the removable water tank.

### DETAILED DESCRIPTION

It Will be appreciated that the following description is intended to refer to specific embodiments of the invention selected for illustration in the drawings and is not intended to define or limit the invention, other than in the appended claim.

This invention provides a wheel equipped with a guiding device which promotes learning manual shaping motions, notably for the creation of small pottery. This wheel is particularly, but not exclusively, intended for children learning pottery molding.

One aspect of the invention comprises a pottery wheel for shaping pottery comprising a base supporting a disk that can be driven in rotation along an axis of rotation, characterized in that it comprises a guiding device comprising means that enable operations on the pottery of diametrically opposed manual efforts in relation to the axis of rotation of the disk.

According to a preferred embodiment, the guiding device comprises at least one lug having an axis essentially parallel to the axis of rotation of the disk as well as at least one guiding arm for a tool, the guiding arm being mobile in relation to the lug. The guiding device preferably comprises an arch-shaped support by two lugs connected to each other.

According to one embodiment, the support comprises a cylindrical form of inverted U shape. The tool or tools each advantageously have an interchangeable work surface. Each tool preferably has a handle. According to one aspect, the handle is located on a surface opposite the tool's work surface. According to another aspect, the handle is radially offset in relation to the tool's work surface.

According to yet another aspect, the base has a recess that can house a removable water tank to allow collection of water used for shaping and to more easily dispose of the water.

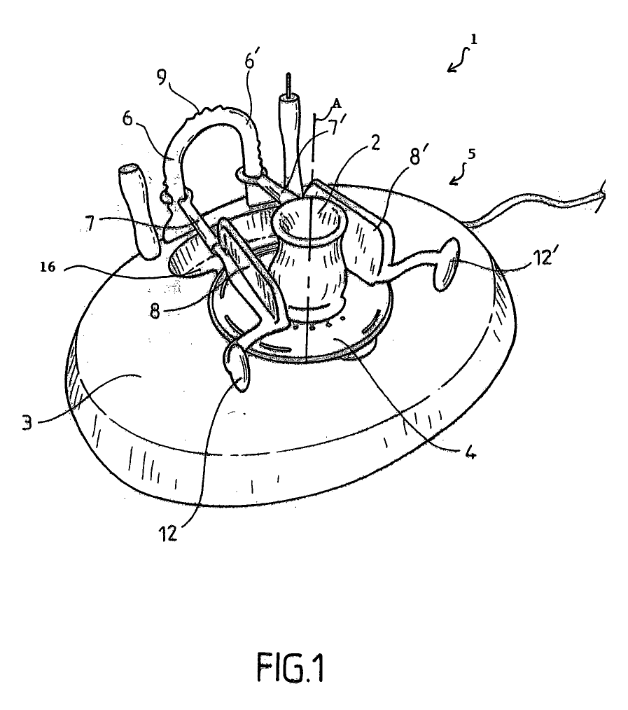

Turning now to the drawings, the pottery wheel (1) illustrated in FIG. 1 is of the type comprising a base (3) comprising an electric motor for driving in rotation along an axis of rotation A a disk (4) supported by the base (3).

In a preferred aspect, a receptacle is positioned under the circular tray supporting the rotating pottery or disk (4) for recovering liquids evacuated at the periphery of the disk. The tray is also pierced by holes discharging into this bowl. The liquids recovered in the receptacle then flow into a water tank (16).

The pottery wheel (1) comprises a guiding device (5) comprising means for performing on said pottery (2) diametrically opposed manual efforts in relation to the axis A of rotation of the disk (4).

The pottery shaping and centering operations are performed by a lateral approaching of the guiding arms. In this manner, the tools exert pressure on the pottery which makes shaping easier and enables decoration by marking of the external surface.

According to one aspect, the guiding device comprises at least one vertical lug (6, 6′) having an axis preferably essentially parallel to the axis A of rotation of the disk (4) as well as at least one guiding arm (7, 7′) and preferably two guiding arms (7, 7′) for guiding, respectively, a tool (8, 8′), the guiding arm(s) (7, 7′) being movable in relation to the lug(s) (6, 6′).

According to a preferred aspect, the guiding arm(s) (7, 7′) is (are) fixed in a removable manner on the lug(s) (6, 6′), e.g., by clipping means or the like.

It is also possible to create guiding means that enable translational movement of the tools according to diametrically opposed radial movements in relation to the axis A of rotation of the disk (4), e.g., by rail systems or the like.

According to one aspect, the guiding device (5) comprises an arch-shaped support (9) formed by two lugs (6, 6′) connected to each other and on which one or two arms (7, 7′) are mobile.

The guiding device is preferably created by two lugs positioned diametrically opposed along a plane passing through the axis A of rotation of the disk (4).

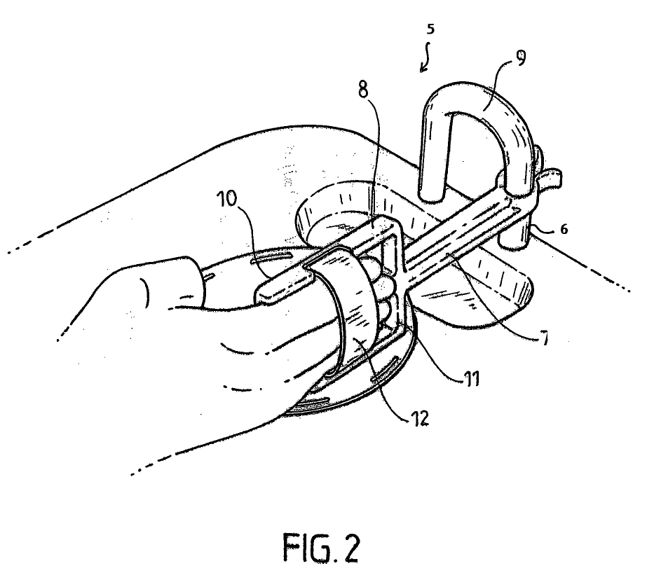

In a preferred version illustrated in FIG. 2, the guiding device (5) comprises an arch of cylindrical form of inverted U shape. The two lugs constituting the arch each have a section of circular form and an axis essentially parallel to the axis A of rotation of the disk. One or two arms (7, 7′) for guiding a tool (8, 8′) is (are) movable on this arch. Each arm (7, 7′) can implement rotational movements around the lug (6, 6′) along the vertical axis of the lug, thereby enabling working on the form of the pottery and control of its diameter. Each arm (7, 7′) can also be displaced vertically along the lug (6, 6′), thereby controlling the shaping height.

According to another aspect, a guiding arm (7, 7′) can also be placed on the top curved part of the arch connecting the two lugs (6, 6′), thereby enabling the shaping of the upper part of the pottery. According to a preferred aspect, the arch has recesses that can be used to support the arms and regulate their height at specific values.

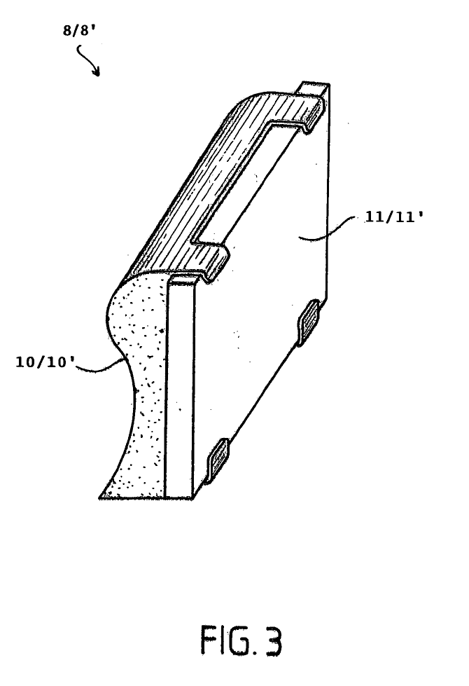

The tool (8, 8′) may have an interchangeable work surface (10, 11), that can be removable or attached, for example, by clipping means to the tool (8, 8′) as illustrated in FIG. 3. During the fabrication process, the user can thus use different tools depending on the action that the user wants to perform: centering, shaping or decoration of the pottery.

Moreover, the tool (8, 8′) has a handle (12, 12′). According to one aspect, the handle (12, 12′) is located on a surface (11, 11′) opposite to a work surface (10, 10′). The user can thus place hands flat behind the tool and thereby come close to the motion performed with bare hands by the potter.

According to another aspect of the tool illustrated in FIG. 1, the handle (12, 12′) is radially offset along the axis A in relation to a work surface (10, 10′). This type of handle allows the user to apply a greater force on each side of the pottery. In this other aspect, the handles (12, 12′) have, e.g., a T shape.

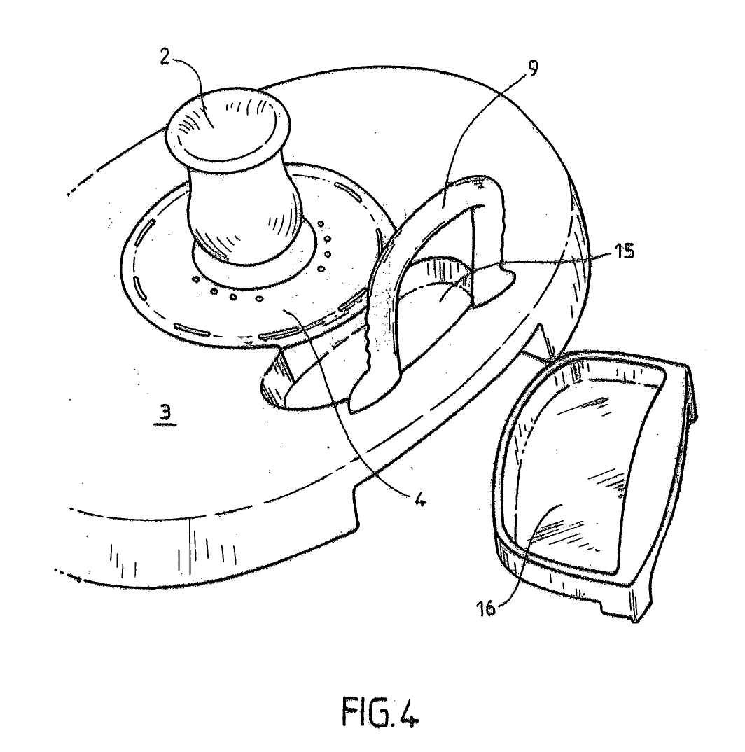

The base (3) is made of plastic and has cavities for storing tools. It has a recess (15) for housing a removable water tank (16) as illustrated in FIG. 4.

The invention is described above as an example. It is understood that those skilled in the art can implement different aspects of the invention without going beyond the scope of the appended claims.

1. A pottery wheel for shaping pottery comprising:
a base supporting a disk that can be driven in rotation along an axis of rotation (A), and
a guide comprising means enabling operations on the pottery of diametrically opposed manual efforts in relation to the axis of rotation (A) of the disk by at least one tool.

2. The pottery wheel according to claim 1, wherein the guide has at least one lug having an axis essentially parallel to the axis A of rotation of the disk and at least one arm for guiding the tool, the guiding arm being movable in relation to said lug.

3. The pottery wheel according to claim 2, wherein the guide comprises an arch-shaped support formed by two lugs connected to each other.

4. The pottery wheel according to claim 3, wherein the support comprises a cylindrical form of inverted U shape.

5. The pottery wheel according to claim 1, wherein the tool has an interchangeable work surface.

6. The pottery wheel according to claim 1, wherein the tool further comprises a handle.

7. The pottery wheel according to claim 6, wherein the handle is located on a surface opposite a work surface.

8. The pottery wheel according to claim 6, wherein the handle is radially offset in relation to a work surface.

9. The pottery wheel according to claim 1, wherein the base has a recess for housing a removable water tank.

10. A pottery wheel for shaping pottery comprising:
a base supporting a disk that can be driven in rotation along an axis of rotation (A), and
a guide enabling manipulation of the pottery by opposed manual efforts in relation to the axis of rotation (A) of the disk with at least one tool.

11. The pottery wheel according to claim 10, wherein the guide comprises at least one lug having an axis substantially parallel to the axis A of rotation of the disk and at least one arm for guiding a tool, the guiding arm being movable in relation to the lug.

12. The pottery wheel according to claim 11, wherein the guide comprises an arch-shaped support formed by two lugs connected to each other.

13. The pottery wheel according to claim 12, wherein the support comprises a cylindrical form of inverted U shape.

14. The pottery wheel according to claim 10, wherein the tool has an interchangeable work surface.

15. The pottery wheel according to claim 10, wherein the tool has at least one handle.

16. The pottery wheel according to claim 15, wherein the handle is located on a surface opposite a work surface.

17. The pottery wheel according to claim 15, wherein the handle is radially offset in relation to a work surface.

18. The pottery wheel according to claim 10, wherein the base has a recess for housing a removable water tank.
